(19) United States
(12) Patent Application Publication
(10) Pub. No.: US 2018/0367197 A1
(43) Pub. Date: Dec. 20, 2018

(54) Method And Apparatus For Linear Combination Codebook Design And CSI Feedback In Mobile Communications

(71) Applicant: MediaTek Inc., Hsinchu City (TW)

(72) Inventors: Weidong Yang, San Diego, CA (US); Lung-Sheng Tsai, Hsinchu City (TW)

(21) Appl. No.: 16/010,432

(22) Filed: Jun. 16, 2018

Related U.S. Application Data
(63) Continuation-in-part of application No. 15/865,457, filed on Jan. 9, 2018.
Application No. 15/865,457 is a continuation-in-part of application No. 15/969,747, filed on May 2, 2018.
(60) Provisional application No. 62/521,231, filed on Jun. 16, 2017.
(60) Provisional application No. 62/523,334, filed on Jun. 22, 2017.

(51) Int. Cl. H04B 7/0456; H04B 7/0452; H04B 7/0417

(52) U.S. Cl. CPC H04B 7/0478; H04B 7/0417; H04B 7/0452

(57) ABSTRACT

Techniques and examples pertaining to linear combination codebook design and channel state information (CSI) feedback in mobile communications are described. Frequency-dependent parameterization is supported to reduce signaling overhead in reporting beam selection and to enhance CSI resolution. Additionally, the number of candidates for beam selection depends on the strength of each beam to be selected such that more candidates are considered for a stronger beam than for a weaker beam. Moreover, amplitude quantization and/or phase quantization for beams of different strengths are different to reduce quantization error.

### CROSS REFERENCE TO RELATED PATENT APPLICATION

The present disclosure claims the priority benefit of U.S. Provisional Patent Application No. 62/521,231, filed 16 Jun. 2017, and U.S. Provisional Patent Application No. 62/523,334, filed 22 Jun. 2017. The present disclosure is also a part of a Continuation-in-Part (CIP) application of U.S. Utility patent application Ser. No. 15/865,457, filed 9 Jan. 2018 and a part of a CIP application of U.S. Utility patent application Ser. No. 15/969,747, filed 2 May 2018. Contents of above-listed applications are herein incorporated by reference in their entirety.

### TECHNICAL FIELD

The present disclosure is generally related to mobile communications and, more particularly, to linear combination codebook design and channel state information (CSI) feedback in mobile communications.

### BACKGROUND

Unless otherwise indicated herein, approaches described in this section are not prior art to the claims listed below and are not admitted as prior art by inclusion in this section.

In 5^{th} Generation (5G) New Radio (NR) networks, two types of channel CSI feedback schemes, Type I and Type II, have been defined. In Type I of CSI feedback, the conventional dual codebook structure is enforced. Type II of CSI feedback targets high-resolution CSI acquisition for multi-user multiple-input-and-multiple-output (MU-MIMO) operations. A linear combination codebook is assumed for Type II CSI feedback. There are three categories under Type II, namely Category I, Category II and Category III. With Category I, a linear combination (LC) codebook is assumed.

With Category II of Type II of CSI feedback, channel covariance matrix R measured at a user equipment (UE) is fed back from that UE to the network to facilitate MU-MIMO transmission. For effective MU-MIMO transmission with small cross-talk, typically subband feedback is necessary. Hence, subband feedback with the covariance matrix may be necessary.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose a scheme to reduce overhead for reporting beam-selection in linear combination-based CSI feedback. Another objective of the present disclosure is to propose a scheme to reduce quantization error in representing amplitude and phase of linear combination coefficients.

In one aspect, a method may involve a processor of a user equipment (UE) receiving, from a network node of a wireless network, one or more reference signals via a communication link between the UE and the network node. The method may also involve the processor constructing a linear combination-based CSI feedback by utilizing a precoder which is a continuous function of frequency such that the CSI feedback indicates one or more linear combination codebook coefficients each being a continuous function of frequency. The method may further involve the processor transmitting the CSI feedback to the network node.

In one aspect, a method may involve a processor of a UE measuring one or more reference signals from a network node of a wireless network. The method may also involve the processor selecting a set of selected beams from a plurality of beams by: (1) determining, based on the measuring, at least one high-power beam among the plurality of beams as a chosen beam; and (2) searching in a spatial region around the chosen beam to identify one or more other beams each having a power no greater than that of the chosen beam, the chosen beam and the one or more other beams being the selected beams. The method may further involve the processor generating a report indicating the selected beams. The method may further involve the processor transmitting the report to the network node.

It is noteworthy that, although description of the proposed scheme and various examples is provided below in the context of 5th Generation (5G) New Radio (NR) wireless communications, the proposed concepts, schemes and any variation(s)/derivative(s) thereof may be implemented in communications in accordance with other protocols, standards and specifications where implementation is suitable. Thus, the scope of the proposed scheme is not limited to the description provided herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 shows a comparison between an example scheme of bit allocation for frequency-correlated parameterization in accordance with an implementation of the present disclosure and a conventional bit allocation for NR linear combination codebook.

FIG. 2 is a diagram of an example scenario of beam search in accordance with an implementation of the present disclosure.

FIG. 3 is a diagram of an example communications system in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to mobile country code recognition with respect to user equipment in mobile communications. According to the present disclosure, a number of possible solutions may be implemented separately or jointly. That is, although these possible solutions may be described below separately, two or more of these possible solutions may be implemented in one combination or another.

Linear Combination-Based CSI Feedback with Reduced Overhead

Linear combination codebooks can provide CSI at higher resolution than that with Type I dual codebooks. Typically, a linear combination codebook is associated with heavy feedback overhead. Hence, there is a need to explore methods to reduce feedback overhead of linear combination codebooks or, equivalently, achieve a higher resolution with a given overhead.

Under a proposed scheme in accordance with the present disclosure, correlation of the channel response in the frequency domain is exploited to reduce the feedback overhead and to enable CSI with higher resolution. In the framework of NR, as beam selection is wideband, it is expected that correlation in the frequency domain can be exploited to reduce feedback overhead. As linear combination targets MU-MIMO, sub-band feedback is expected. One reasonable design is to require the precoder to be a continuous function of frequency. Consequently, the linear combination coefficients, which may include amplitude coefficients P_{r,l}_{₁}_{,l}_{₂} and/or phase coefficients C_{r,l}_{₁}_{,l}_{₂}, may be a continuous function of frequency. Here, r=0,1 for polarization (e.g., r=0 for polarization at 45° and r=1 for polarization at −45°), 0≤l₁≤L₁−1 for spatial layer, L₁ is the rank of the codeword, 0≤l₂≤L−1, and L is the number of basis vectors per polarization. Accordingly, different interpolation functions with polynomials and/or sinusoids may be utilized to synthesize these coefficients.

In general, Type II category 1 feedback with the considered design can be formulated as shown below in Mathematical Expression (1).

$$W = \underbrace{[ \begin{matrix}B & 0 \\ 0 & B\end{matrix} ]}_{{W}_{1}} [ \begin{matrix}{Q}_{0} & 0 \\ 0 & {Q}_{1}\end{matrix} ] \\ {Q}_{0} = {[ \begin{matrix}{Q}_{0 , 0 , 0} & … & {Q}_{0 , R - 1 , 0} \\ {Q}_{0 , 0 , 1} & … & {Q}_{0 , R - 1 , 1} \\ ⋮ & ⋮ & ⋮ \\ {Q}_{0 , 0 , L - 1} & … & {Q}_{0 , R - 1 , L - 1}\end{matrix} ]}_{L \times R} \\ {Q}_{1} = {[ \begin{matrix}{Q}_{1 , 0 , 0} & … & {Q}_{1 , R - 1 , 0} \\ {Q}_{1 , 0 , 1} & … & {Q}_{1 , R - 1 , 1} \\ ⋮ & ⋮ & ⋮ \\ {Q}_{1 , 0 , L - 1} & … & {Q}_{1 , R - 1 , L - 1}\end{matrix} ]}_{L \times R} \qquad ( 1 )$$

Here, Q_{r,l}_{₁}_{,l}_{₂} stands for LC coefficients for {r,l₁,l₂}, with r=0,1 for polarization (e.g., r=0 for polarization at 45° and r=1 for polarization at −45°), 0≤l₁≤R−1 for spatial layer, R is the rank of the codeword, 0≤l₂≤L−1, and L is the number of chosen basis vectors per polarization.

When the polynomial basis is used, a first order polynomial or a second order polynomial model, Q_{r,l}_{₁}_{,l}_{₂} (f)≈a_{(0,r,l}_{₁}_{,l}_{₂}₎+a_{(1,r,l}_{₁}_{,l}_{₂}₎f+a_{(2,r,l}_{₁}_{,l}_{₂}₎f² with scalars a_{(k,r,l}_{₁}_{,l}_{₂}₎, 0≤k≤2, may be an example to approximate Q_{r,l}_{₁}_{,l}_{₂} (f) over multiple frequency bands with the polynomial bases. When other bases are used (e.g., sine functions, spline function and the like), corresponding coefficients can be used.

For each {r, l₁, l₂}, feedback from UE, {a_{(0,r,l}_{₁}_{,l}_{₂}₎,a_{(1,r,l}_{₁}_{,l}_{₂}₎,a_{(2,r,l}_{₁}_{,l}_{₂}₎}, can provide the amplitude and phase for linear combination at multiple sub-bands. It is possible that a single approximation (e.g., a second-order polynomial with {a_{(0,r,l}_{₁}_{,l}_{₂}₎,a_{(1,r,l}_{₁}_{,l}_{₂}₎}) may not be valid or optimal for all frequency bands, then piece-wise approximations over multiple band sets may be used. For example, a first set of {a_{(0,r,l}_{₁}_{,l}_{₂}₎,a_{(1,r,l}_{₁}_{,l}_{₂}₎,a_{(2,r,l}_{₁}_{,l}_{₂}₎} may be used for bands 1˜10, and a second set of {a_{(0,r,l}_{₁}_{,l}_{₂}₎,a_{(1,r,l}_{₁}_{,l}_{₂}₎,a_{(2,r,l}_{₁}_{,l}_{₂}₎} may be used for bands 11˜20.

In another example, frequency-dependent parameterization can be exploited separately in the amplitude part and in the phase part of the linear combination, or in either the amplitude part or the phase part. With Q_{r,l}_{₁}_{,l}_{₂}(f)=P_{r,l}_{₁}_{,l}_{₂}(f)×exp(\sqrt{−1}A_{r,l}_{₁}_{,l}_{₂}(f)), and C_{r,l}_{₁}_{,l}_{₂}(f)=exp(\sqrt{−1}A_{r,l}_{₁}_{,l}_{₂}(f)), f denotes frequency (e.g., frequency band index). By the notation P_{r,l}_{₁}_{,l}_{₂}(f), the amplitude part in the linear combination may be frequency-dependent. Moreover, interpolation of the co-phasing term C_{r,l}_{₁}_{,l}_{₂}(f) may be performed in the angular domain (e.g., assuming A_{r,l}_{₁}_{,l}_{₂}(f) can be approximated by a second-order polynomial with real coefficients), or it may be assumed that C_{r,l}_{₁}_{,l}_{₂}(f) can be approximated, for example, by a second-order polynomial with complex coefficients.

Under the proposed scheme, frequency domain correlation may be exploited for some, not all, parameters used in the determination of a codeword. Accordingly, as an example, the frequency domain interpolation may be used for P_{r,l}_{₁}_{,l}_{₂} but not for C_{r,l}_{₁}_{,l}_{₂}, or vice versa.

Equivalent to the parameterization (e.g., through polynomial basis), a number of signaled values at given frequency locations may also be used to reconstruct the parameterization model. This can be understood as if f(x)=a₀+a₁x+a₂x², then a₀, a₁, a₂ may be found or otherwise determined from {f(x₁), f(x₂) and f(x₃)} (e.g., explicitly signaled amplitudes and/or powers) and {x₁, x₂ and x₃} (e.g., sub-band indices) through curve fitting. Hence, equivalent to frequency-dependent parameterization, in case that values (amplitudes/powers/phases) at known frequent sub-bands x₁, x₂, x₃ . . . are given, and the second-order polynomial basis is assumed, a₀, a₁, a₂ can be found as described above. In case that the first-order polynomial basis is assumed (e.g., f(x)=a₀+a₁x), then piece-wise linear curve fitting over [x₁ x₂] and [x₂ x₃] may be used to find f(x), x₁<x<x₂, and x₂<x<x₃.

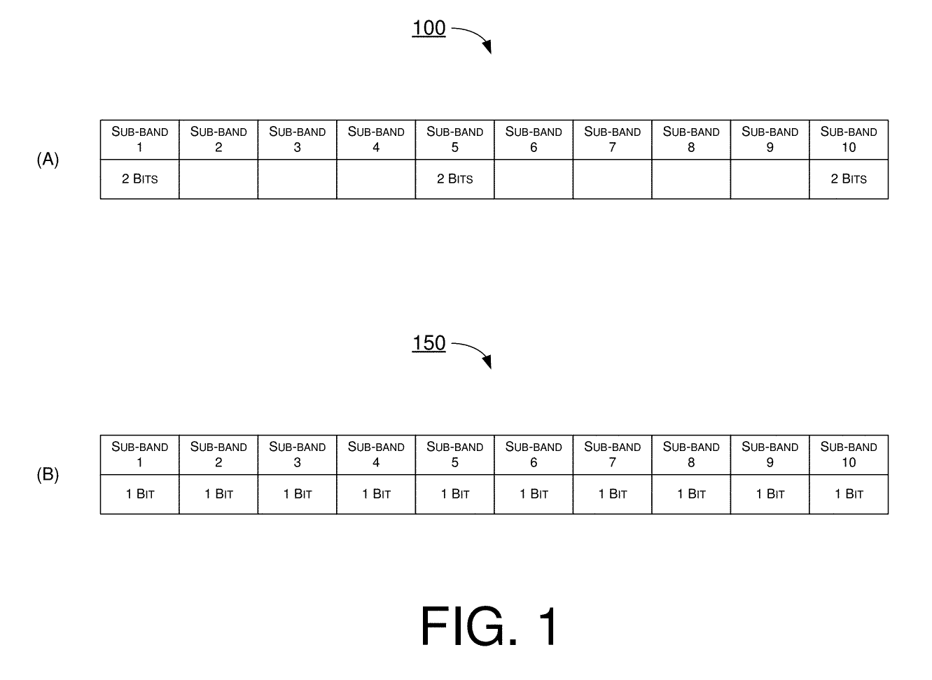

FIG. 1 illustrates a comparison between an example scheme 100 of bit allocation for frequency-correlated parameterization in accordance with an implementation of the present disclosure and a conventional scheme 150 of bit allocation for NR linear combination codebook. Part (A) of FIG. 1 shows scheme 100 of bit allocation for frequency-correlated parameterization in accordance with an implementation of the present disclosure. Part (B) of FIG. 1 shows a conventional scheme 150 of bit allocation for NR linear combination codebook.

Under scheme 100, in the example shown in part (A) of FIG. 1, at sub-bands 1, 5 and 10 the sub-band amplitude and/or power of the respective sub-band may be indicated by a 2-bit field (e.g., for {1, \sqrt{0.5}, \sqrt{0.3548}, \sqrt{0.25}}). For other sub-bands without the explicitly signaled sub-band amplitude, interpolation through curve fitting may be applied to the indicated amplitudes/powers of two neighboring sub-bands with explicitly signaled sub-band amplitudes/powers. Scheme 100 may be applied for phases as well.

Of course, there needs to be mutual understanding on the UE side and the network side on the frequency-dependent parametrization method, including the curve fitting basis and sub-band indices with explicitly indicated amplitudes/powers according to scheme 100. As an example, the network may configure or specify a curve fitting basis for a UE, and the UE may use the curve fitting basis for sub-band feedback with respect to amplitudes, powers and phases. Additionally, the UE may feedback a number of values (e.g., amplitudes or phases) potentially at a higher resolution compared to existing design at prescribed sub-bands. On the network side, from the indices of the prescribed sub-bands as well as the feedback from the UE, the network may use the curve fitting basis to deduce the relevant values at other sub-bands.

Advantageously, under scheme 100, overhead for reporting beam-selection in linear combination-based CSI feedback may be reduced. That is, frequency-dependent parameterization may be supported under scheme 100 to reduce signaling overhead as well as to enhance CSI resolution.

### Linear Combination Codebook Design

Type II CSI feedback is a linear combination-based approach to represent channel information to be reported in NR. However, one issues is that, with unconstrained beam selection adopted for L=2, 3, 4, signaling overhead to indicate the selected beam indices from [0 . . . N₁−1]×[0 . . . N₂−1] may be relatively large. In Type I, beam group selection and beam selection within a group are quite rigid. In contrast, in Type II category 1, beam selection for linear combination has the most flexibility since, basically, all the orthogonal beams are legitimate candidates. The present disclosure aims to propose a scheme to balance between the two extremes described above.

Under a proposed scheme in accordance with the present disclosure, for high-power beams, beam selection may be flexible as with Type II category 1 (e.g., for the top two beams for a total of four beams). For beams of lower power, the search may be limited to be around a spatial region or neighborhood of the chosen (high-power) beam(s).

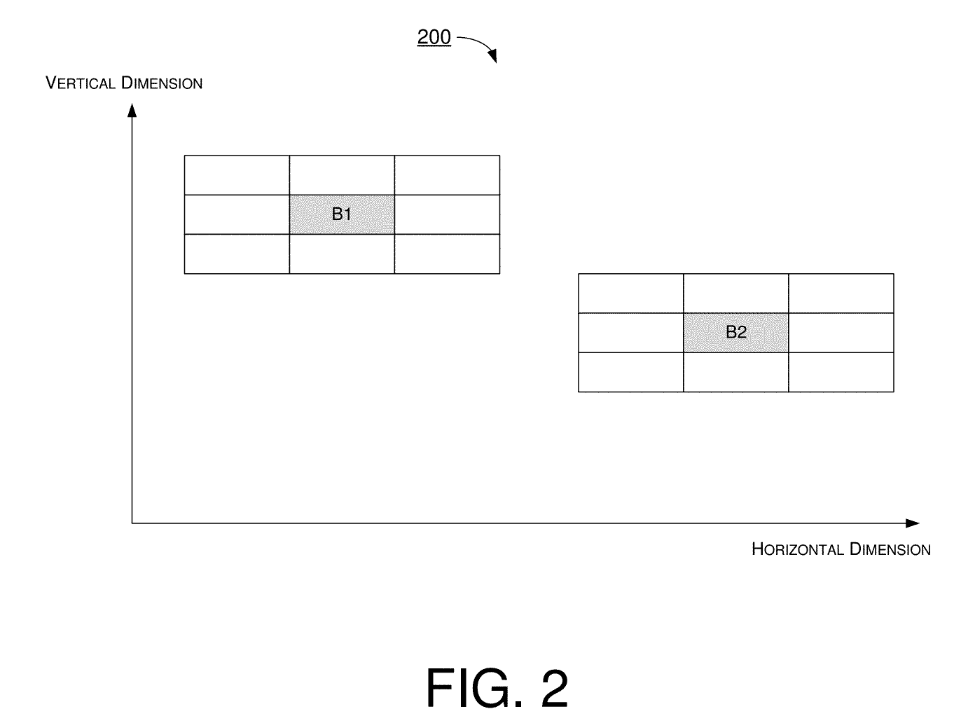

FIG. 2 illustrates an example scenario 200 of beam search in accordance with an implementation of the present disclosure. In scenario 200, beams B1 and B2 are for two chosen high-power beams, and they may be orthogonal or non-orthogonal beams. The next beam search may be constrained to the spatial region or neighborhood around each of beams B1 and B2. That is, the spatial region may be considered as including an array of multiple geometric shapes arranged in a M×N dimension of M rows and N columns centered around each chosen (high-power) beam, with the chosen beam in a geometric shape in a center of the array and with each of M and N being a positive integer greater than 1. In scenario 200, the spatial region includes an array of nine geometric shapes arranged in a 3×3 dimension of three rows and three columns centered around the chosen beam. In scenario 200, the shape of the geometric shapes of the spatial region or neighborhood is a rectangle, as shown in FIG. 2, with the chosen beam (B1 or B2) being in the center rectangle. Taking L=4 for example and assuming two beams other than beams B1 and B2 are selected from the 3×3 rectangle, the overhead to signal L-beam selection is reduced from

$$⌈ {log}_{2} ( \begin{matrix}{N}_{1} {N}_{2} \\ L\end{matrix} ) ⌉$$

bits to

$$⌈ {log}_{2} ( \begin{matrix}{N}_{1} {N}_{2} \\ 2\end{matrix} ) ⌉ + ⌈ {log}_{2} ( \begin{matrix}8 \\ 2\end{matrix} ) ⌉$$

bits. It is noteworthy that other shapes (e.g., a circle, an ellipse or a polygon such as square, hexagon, octagon, or any other multi-side shape) may be used as the “neighborhood” for beam search. Thus, under the proposed scheme, the number of candidates for beam selection may depend on a sorted order of strength of each beam to be selected. More candidates may be provided for a stronger beam, and fewer candidates may be provided for a weaker beam.

Another issue is that conventionally the quantization method is universal such that the same phase and amplitude quantization method is also used for the second strongest beam, the third strongest beam and so forth. It is expected that amplitude distribution for the second strongest beam and the third strongest beam and so forth tends to follow different distributions. This point can be demonstrated by assuming that there are L=4 independent and identically distributed random variables, xₖ, 1≤k≤L, following the same distribution f(x). In case that {xₖ} is sorted in the descending order to obtain {yₖ} so that yₖ≤x_{k′}, and y₁≥y₂≥y₃≥y₄, then in general y₁ follows a different distribution from that for y₄ by a theory of order statistics.

In general, the optimal quantizer for one distribution can be different from that for another distribution. For example, for zero-mean, unit variance distributions, the optimal quantizer for the uniform distribution has intervals given by [−1.00,−0.88,−0.75,−0.63,−0.50,−0.38,−0.25,−0.13,0.00,0.13,0.25,0.38,0.50,0.63,0.75,0.88,1.00] (sixteen intervals in total), and the optimal quantizer for the Gamma distribution has intervals given by [−4.32,−3.78,−3.24,−2.70,−2.16,−1.62,−1.08,−0.54,0.00,0.54,1.08,1.62,2.16,2.70,3.24,3.78,4.32].

Under a proposed scheme in accordance with the present disclosure, the amplitude and/or phase quantization schemes for beams of different strengths may be different so as to reduce quantization error. That is, the quantizers for amplitude and/or phase of different beams (sorted according to strength) may be optimized separately. Under the proposed scheme, a procedure may generate many channel realizations and perform computation for linear combination codebook coefficients (amplitude coefficients and phase coefficients) without quantization for each of the coefficients. The procedure may also collect statistics for the amplitude and phase coefficients for different beams (which may be wideband or sub-band). The procedure may fit the collected statistics to distribution and identify the optimal distribution and its corresponding optimal quantizer. Alternatively, the Lloyd-Max iterative algorithm may be utilized on the collected statistics. A summary on the Lloyd-Max iterative algorithm is provided below for a continuous variable x.

For a signal x with a given probability density function fₓ(x), a quantizer with Q representative levels (such that d=MSE=E[(X−\hat{X})²]→minimum) may be found by performing the following:
1. Provide an initial set of representative levels \hat{x}_{q}, 0≤q≤Q−1.
2. Calculate decision thresholds t_{q}=½(\hat{x}_{q-1}+\hat{x}_{q}), q=1, 2, . . . , Q−1.
3. Calculate new representative levels

$${\hat{x}}_{q} = \frac{{\int }_{{t}_{q}}^{{t}_{q + 1}} x \cdot {f}_{X} ( x ) dx}{{\int }_{{t}_{q}}^{{t}_{q + 1}} {f}_{X} ( x ) dx} ,$$

q=0, 1, 2, . . . , Q−1.
4. Repeat steps 2 and 3 until there is no further reduction in distortion d.

For a collected statistics with {sₖ, k=1, . . . , K}, where K is the number of the collected samples, the Lloyd-Max iterative algorithm may involve performing the following:
1. Provide an initial set of representative levels \hat{x}_{q}, 0≤q≤Q−1.
2. Calculate decision thresholds t_{q}=½(\hat{x}_{q-1}+\hat{x}_{q}), q=1, 2, . . . , Q−1.
3. Calculate new representative levels

$${\hat{x}}_{q} = \frac{{\sum }_{{t}_{q} <= {s}_{i} < {t}_{q + 1}} {s}_{i}}{{\sum }_{{t}_{q} <= {s}_{i} < {t}_{q + 1}} 1} ,$$

q=0, 1, 2, . . . , Q−1.
4. Repeat steps 2 and 3 until there is no further reduction in distortion d.

As an example, the Lloyd-Max iterative algorithm may be applied on order statistics generated with four independent and identically distributed random variables following the uniform distribution in [0, 1] with y₄≤y₃≤y₂≤y₁. In this example, for y₁, the optimal threshold is given by 0.3704 0.4988 0.5993 0.6835 0.7569 0.8242 0.8867 0.9449; for y₂, the optimal threshold is given by 0.2351 0.3449 0.4390 0.5262 0.6094 0.6916 0.7754 0.8649; for y₃ , the optimal threshold is given by 0.1352 0.2250 0.3095 0.3925 0.4768 0.5647 0.6600 0.7714; for y₄, the optimal threshold is given by 0.0569 0.1170 0.1810 0.2504 0.3260 0.4109 0.5111 0.6404. It can be observed that the optimal quantization thresholds for y₄ are significantly different those for y₁.

Accordingly, the number of candidates considered for beam selection may depend on the strength order of each beam to be selected. That is, more candidates may be considered for a stronger beam and fewer candidates may be considered for a weaker beam. Moreover, amplitude quantization and/or phase quantization for beams of different strengths may be different to reduce quantization error.

### Illustrative Implementations

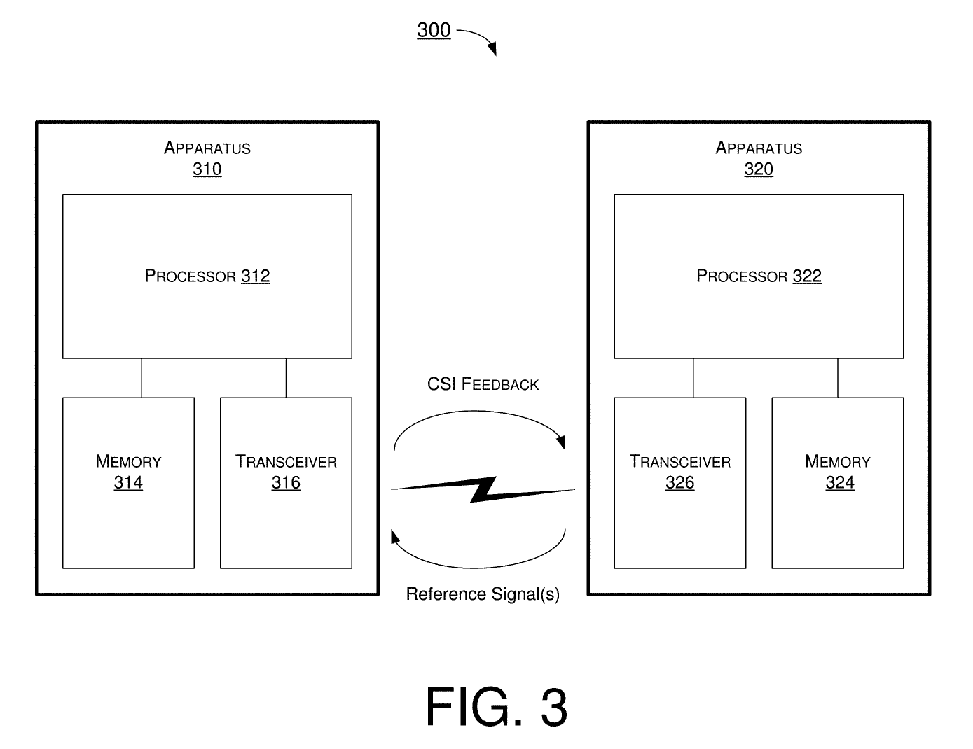

FIG. 3 illustrates an example system 300 having at least an example apparatus 310 and an example apparatus 320 in accordance with an implementation of the present disclosure. Each of apparatus 310 and apparatus 320 may perform various functions to implement schemes, techniques, processes and methods described herein pertaining to linear combination codebook design and CSI feedback in mobile communications, including the various schemes described above with respect to various proposed designs, concepts, schemes, systems and methods described above as well as processes 400, 500 and 600 described below.

Each of apparatus 310 and apparatus 320 may be a part of an electronic apparatus, which may be a network apparatus or a UE, such as a portable or mobile apparatus, a wearable apparatus, a wireless communication apparatus or a computing apparatus. For instance, each of apparatus 310 and apparatus 320 may be implemented in a smartphone, a smartwatch, a personal digital assistant, a digital camera, or a computing equipment such as a tablet computer, a laptop computer or a notebook computer. Each of apparatus 310 and apparatus 320 may also be a part of a machine type apparatus, which may be an Internet-of-Things (loT) apparatus such as an immobile or a stationary apparatus, a home apparatus, a wire communication apparatus or a computing apparatus. For instance, each of apparatus 310 and apparatus 320 may be implemented in a smart thermostat, a smart fridge, a smart door lock, a wireless speaker or a home control center. When implemented in or as a network apparatus, apparatus 310 and/or apparatus 320 may be implemented in an eNodeB in an LTE, LTE-Advanced or LTE-Advanced Pro network or in a gNB or TRP in a 5G network, an NR network or an loT network.

In some implementations, each of apparatus 310 and apparatus 320 may be implemented in the form of one or more integrated-circuit (IC) chips such as, for example and without limitation, one or more single-core processors, one or more multi-core processors, or one or more complex-instruction-set-computing (CISC) processors. In the various schemes described above, each of apparatus 310 and apparatus 320 may be implemented in or as a network apparatus or a UE. Each of apparatus 310 and apparatus 320 may include at least some of those components shown in FIG. 3 such as a processor 312 and a processor 322, respectively, for example. Each of apparatus 310 and apparatus 320 may further include one or more other components not pertinent to the proposed scheme of the present disclosure (e.g., internal power supply, display device and/or user interface device), and, thus, such component(s) of apparatus 310 and apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including those pertaining to linear combination codebook design and CSI feedback in mobile communications in accordance with various implementations of the present disclosure.

In some implementations, apparatus 310 may also include a transceiver 316 coupled to processor 312. Transceiver 316 may be capable of wirelessly transmitting and receiving data. In some implementations, apparatus 320 may also include a transceiver 326 coupled to processor 322. Transceiver 326 may include a transceiver capable of wirelessly transmitting and receiving data.

In some implementations, apparatus 310 may further include a memory 314 coupled to processor 312 and capable of being accessed by processor 312 and storing data therein. In some implementations, apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

For illustrative purposes and without limitation, a description of capabilities of apparatus 310 and apparatus 320 is provided below in the context of apparatus 310 functioning as a UE and apparatus 320 functioning as a network node (e.g., eNB, gNB or TRP) of a wireless network (e.g., a 5G NR network).

In one aspect, processor 312 of apparatus 310 (as a UE) may receive, via transceiver 316 and from apparatus 320 (as a network node of a wireless network), one or more reference signals via a communication link between apparatus 310 the UE and apparatus 320 the network node. Additionally, processor 312 may construct a linear combination-based CSI feedback by utilizing a precoder which is a continuous function of frequency such that the CSI feedback indicates one or more linear combination codebook coefficients each being a continuous function of frequency. Moreover, processor 312 may transmit, via transceiver 316, the CSI feedback to apparatus 320.

In some implementations, in constructing the linear combination-based CSI feedback, processor 312 may generate a report for the CSI feedback with the report comprising a number of fields each signaling linear-combination codebook coefficients of a respective sub-band of at least two non-contiguous sub-bands of a plurality of sub-bands. Moreover, linear-combination codebook coefficients of a sub-band between the two non-contiguous sub-bands may be obtainable via interpolation by applying curve fitting to linear-combination codebook coefficients of the two non-contiguous sub-bands.

In some implementations, the one or more linear combination codebook coefficients may include one or more amplitude coefficients, one or more phase coefficients, or a combination thereof.

In some implementations, in constructing the linear combination-based CSI feedback, processor 312 may perform at least one of: (1) frequency-dependent parameterization in an amplitude part of the linear combination; (2) frequency-dependent parameterization in a phase part of the linear combination; or (3) frequency-dependent parameterization in the amplitude part and the phase part of the linear combination, with the frequency-dependent parameterization in the amplitude part and the frequency-dependent parameterization in the phase part performed separately.

In some implementations, the frequency-dependent parameterization may include a set of coefficients associated with a predefined model for interpolation at a plurality of sub-bands. In some implementations, the predefined mode may include a first-order polynomial model, a second-order polynomial model, a high-order polynomial model, a sine function model, or a spline function model. In some implementations, in constructing the linear combination-based CSI feedback, processor 312 may perform piece-wise frequency-dependent parameterizations over a first set of sub-bands of the plurality of sub-bands and a second set of sub-bands of the plurality of sub-bands.

In another aspect, processor 312 may measure a synchronization signal (SS) burst from apparatus 320. Moreover, processor 312 may select a set of one or more selected beams from a plurality of beams by: (1) determining, based on the measuring, at least one high-power beam among the plurality of beams as a chosen beam; and (2) searching in a spatial region around the chosen beam to identify one or more other beams each having a power no greater than that of the chosen beam, the chosen beam and the one or more other beams being the one or more selected beams. Additionally, processor 312 may generate a report indicating the one or more selected beams. Furthermore, processor 312 may transmit, via transceiver 516, the report to apparatus 320.

In some implementations, the report may include bit-fields that separately indicate the chosen beam with high power and other beams as the one or more selected beams.

In some implementations, the report may also indicate quantized linear combination codebook coefficients associated with the one or more selected beams.

In some implementations, the spatial region may include an array of multiple geometric shapes arranged in a M×N dimension of M rows and N columns centered around the chosen beam with the chosen beam in one of the geometric shapes in a center of the array. Each of M and N may be a positive integer. In some implementations, a shape of each of the geometric shapes may be a circle, an ellipse or a polygon.

In some implementations, the one or more selected beams may include beams of different strengths. Moreover, in generating the report indicating the quantized linear combination codebook coefficients associated with the one or more selected beams, processor 312 may perform either or both of: (1) quantizing an amplitude of each linear combination codebook coefficient associated with each of the one or more selected beams using different amplitude quantization schemes based on either the different strengths of the one or more selected beams or a strength order of the one or more selected beams; and (2) quantizing a phase of each linear combination codebook coefficient associated with each of the one or more selected beams using different phase quantization schemes based on either the different strengths of the one or more selected beams or the strength order of the one or more selected beams.

In some implementations, the one or more selected beams may include beams of different strengths. Furthermore, in generating the report indicating the quantized linear-combination codebook coefficients associated with the one or more selected beams, processor 312 may generate a plurality of channel realizations. Additionally, processor 312 may perform computation for linear combination codebook amplitude coefficients and linear combination codebook phase coefficients associated with the one or more selected beams without quantizing the amplitude coefficients and the phase coefficients. Moreover, processor 312 may collect statistics regarding the amplitude coefficients and the phase coefficients for the one or more selected beams. Furthermore, processor 312 may fit the collected statistics to one or more distribution curves. Additionally, processor 312 may identify an optimal distribution and a corresponding optimal quantizer based on a result of the fitting.

In some implementations, in fitting the collected statistics to one or more distribution curves, processor 312 may apply a Lloyd-Max iterative algorithm on the collected statistics.

In some implementations, processor 312 may utilize a first quantizer for the coefficients for a strong beam among the plurality of beams and also utilize a second quantizer for the coefficients for a weak beam among the plurality of beams. The first quantizer and the second quantizer may have different settings of quantization ranges, different numbers of quantization levels, and/or different quantizing step sizes.

It is noteworthy that the quantizer for the coefficient for strong beam and the quantizer (quantization scheme) for the coefficient for a weak beam may have different quantization range and quantizing step size. In some cases, there may be more than one quantization schemes for the linear-combination codebook amplitudes associated with the one or more selected beams that are sorted according to their beam strength. The amplitude and/or phase quantization schemes for beams of different strengths may be different so as to reduce quantization error. That is, the quantizers for amplitude and/or phase of different beams (sorted according to strength) may be optimized separately.

### Illustrative Processes

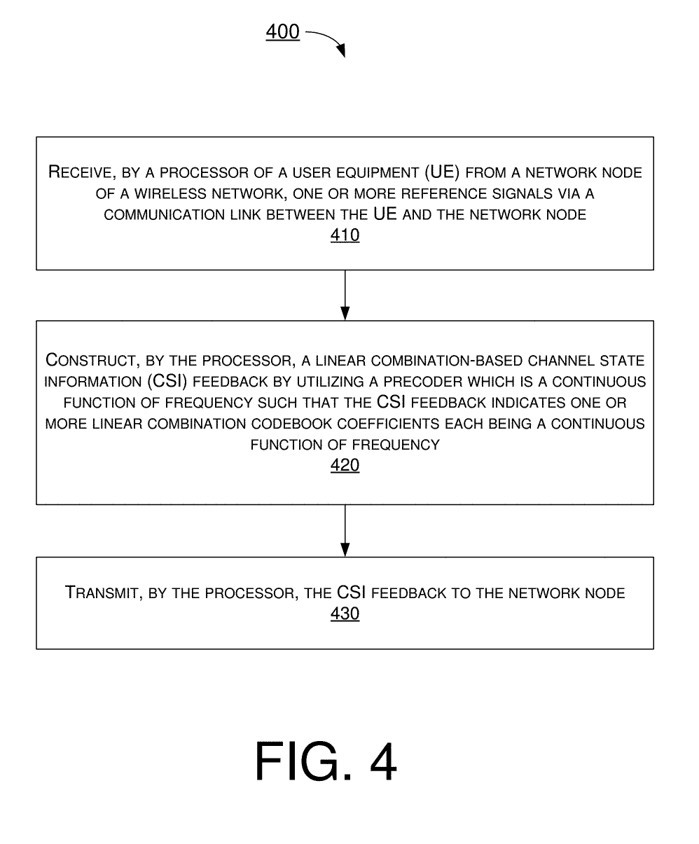

FIG. 4 illustrates an example process 400 of wireless communication in accordance with an implementation of the present disclosure. Process 400 may represent an aspect of implementing the proposed concepts and schemes such as those described above. More specifically, process 400 may represent an aspect of the proposed concepts and schemes pertaining to linear combination codebook design and CSI feedback in mobile communications. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Process 400 may be implemented by communications system 300 and any variations thereof. For instance, process 400 may be implemented in or by apparatus 310 as a UE with apparatus 320 functioning as a network node of a wireless network (e.g., a 5G NR network). Solely for illustrative purposes and without limiting the scope, process 400 is described below in the context of first apparatus 310. Process 400 may begin at block 410.

At 410, process 400 may involve processor 312 of apparatus 310 (as a UE) receiving, via transceiver 316 and from apparatus 320 (as a network node of a wireless network), one or more reference signals via a communication link between the UE and the network node. Process 400 may proceed from 410 to 420.

At 420, process 400 may involve processor 312 constructing a linear combination-based CSI feedback by utilizing a precoder which is a continuous function of frequency such that the CSI feedback indicates one or more linear combination codebook coefficients each being a continuous function of frequency. Process 400 may proceed from 420 to 430.

At 430, process 400 may involve processor 312 transmitting, via transceiver 316, the CSI feedback to apparatus 320.

In some implementations, in constructing the linear combination-based CSI feedback, process 400 may involve processor 312 generating a report for the CSI feedback with the report comprising a number of fields each signaling linear-combination codebook coefficients of a respective sub-band of at least two non-contiguous sub-bands of a plurality of sub-bands. Moreover, linear-combination codebook coefficients of a sub-band between the two non-contiguous sub-bands may be obtainable via interpolation by applying curve fitting to linear-combination codebook coefficients of the two non-contiguous sub-bands.

In some implementations, the one or more linear combination codebook coefficients may include one or more amplitude coefficients, one or more phase coefficients, or a combination thereof.

In some implementations, in constructing the linear combination-based CSI feedback, process 400 may involve processor 312 performing at least one of: (1) frequency-dependent parameterization in an amplitude part of the linear combination; (2) frequency-dependent parameterization in a phase part of the linear combination; or (3) frequency-dependent parameterization in the amplitude part and the phase part of the linear combination, with the frequency-dependent parameterization in the amplitude part and the frequency-dependent parameterization in the phase part performed separately.

In some implementations, the frequency-dependent parameterization may include a set of coefficients associated with a predefined model for interpolation at a plurality of sub-bands. In some implementations, the predefined model may include a first-order polynomial model, a second-order polynomial model, a high-order polynomial model, a sine function model, or a spline function model. In some implementations, in constructing the linear combination-based CSI feedback, process 400 may further involve processor 312 performing piece-wise frequency-dependent parameterizations over a first set of sub-bands of the plurality of sub-bands and a second set of sub-bands of the plurality of sub-bands.

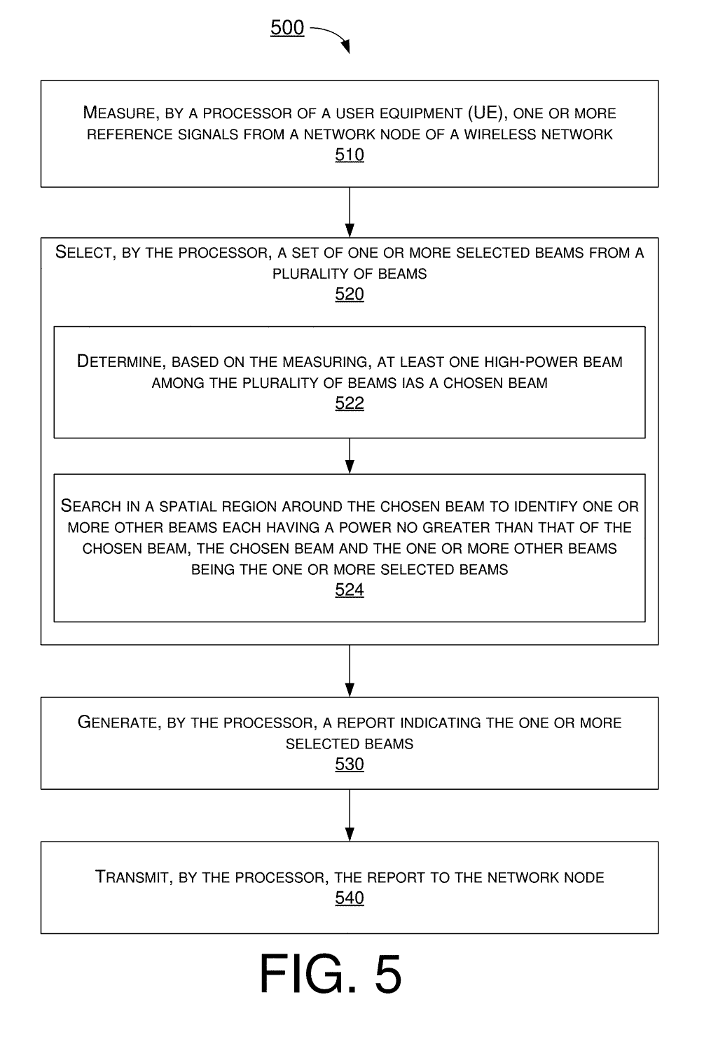

FIG. 5 illustrates an example process 500 of wireless communication in accordance with an implementation of the present disclosure. Process 500 may represent an aspect of implementing the proposed concepts and schemes such as those described above. More specifically, process 500 may represent an aspect of the proposed concepts and schemes pertaining to linear combination codebook design and CSI feedback in mobile communications. Process 500 may include one or more operations, actions, or functions as illustrated by one or more of blocks 510, 520, 530 and 540 as well as sub-blocks 522 and 524. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Process 500 may be implemented by communications system 300 and any variations thereof. For instance, process 500 may be implemented in or by apparatus 310 as a UE with apparatus 320 functioning as a network node of a wireless network (e.g., a 5G NR network). Solely for illustrative purposes and without limiting the scope, process 500 is described below in the context of first apparatus 310. Process 500 may begin at block 510.

At 510, process 500 may involve processor 312 measuring one or more reference signals from apparatus 320. Process 500 may proceed from 510 to 520.

At 520, process 500 may involve processor 312 selecting a set of one or more selected beams from a plurality of beams by performing a number of operations as represented by 522 and 524. Process 500 may proceed from 520 to 530.

At 522, process 500 may involve processor 312 determining, based on the measuring, at least one high-power beam among the plurality of beams as a chosen beam. Process 500 may proceed from 522 to 524.

At 524, process 500 may involve processor 312 searching in a spatial region around the chosen beam to identify one or more other beams each having a power no greater than that of the chosen beam, the chosen beam and the one or more other beams being the one or more selected beams.

At 530, process 500 may involve processor 312 generating a report indicating the one or more selected beams. Process 500 may proceed from 530 to 540.

At 540, process 500 may involve processor 312 transmitting, via transceiver 516, the report to apparatus 320.

In some implementations, the report may include bit-fields that separately indicate the chosen beam with high power and other beams as the one or more selected beams.

In some implementations, the report may also indicate quantized linear combination codebook coefficients associated with the one or more selected beams.

In some implementations, the spatial region may include an array of multiple geometric shapes arranged in a Mx N dimension of M rows and N columns centered around the chosen beam with the chosen beam in one of the geometric shapes in a center of the array. Each of M and N may be a positive integer. In some implementations, a shape of each of the geometric shapes may be a circle, an ellipse or a polygon.

In some implementations, the one or more selected beams may include beams of different strengths. Moreover, in generating the report indicating the quantized linear combination codebook coefficients associated with the one or more selected beams, process 500 may involve processor 312 performing either or both of: (1) quantizing an amplitude of each linear combination codebook coefficient associated with each of the one or more selected beams using different amplitude quantization schemes based on either the different strengths of the one or more selected beams or a strength order of the one or more selected beams; and (2) quantizing a phase of each linear combination codebook coefficient associated with each of the one or more selected beams using different phase quantization schemes based on either the different strengths of the one or more selected beams or the strength order of the one or more selected beams.

In some implementations, the one or more selected beams may include beams of different strengths. Furthermore, in generating the report indicating the quantized linear-combination codebook coefficients associated with the one or more selected beams, process 500 may involve processor 312 performing a number of operations. For instance, process 500 may involve processor 312 generating a plurality of channel realizations. Additionally, process 500 may involve processor 312 performing computation for linear combination codebook amplitude coefficients and linear combination codebook phase coefficients associated with the one or more selected beams without quantizing the amplitude coefficients and the phase coefficients. Moreover, process 500 may involve processor 312 collecting statistics regarding the amplitude coefficients and the phase coefficients for the one or more selected beams. Furthermore, process 500 may involve processor 312 fitting the collected statistics to one or more distribution curves. Additionally, process 500 may involve processor 312 identifying an optimal distribution and a corresponding optimal quantizer based on a result of the fitting.

In some implementations, in fitting the collected statistics to one or more distribution curves, process 500 may involve processor 312 applying a Lloyd-Max iterative algorithm on the collected statistics.

In some implementations, process 500 may further involve processor 312 utilizing a first quantizer for the coefficients for a strong beam among the plurality of beams. Process 500 may also involve processor 312 utilizing a second quantizer for the coefficients for a weak beam among the plurality of beams. The first quantizer and the second quantizer may have different settings of quantization ranges, different numbers of quantization levels, and/or quantizing step sizes.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE) from a network node of a wireless network, one or more reference signals via a communication link between the UE and the network node;
constructing, by the processor, a linear combination-based channel state information (CSI) feedback by utilizing a precoder which is a continuous function of frequency such that the CSI feedback indicates one or more linear combination codebook coefficients each being a continuous function of frequency; and
transmitting, by the processor, the CSI feedback to the network node.

2. The method of claim 1, wherein the constructing of the linear combination-based CSI feedback comprises generating a report for the CSI feedback with the report comprising a number of fields each signaling linear-combination codebook coefficients of a respective sub-band of at least two non-contiguous sub-bands of a plurality of sub-bands, and wherein linear-combination codebook coefficients of a sub-band between the two non-contiguous sub-bands is obtainable via interpolation by applying curve fitting to linear-combination codebook coefficients of the two non-contiguous sub-bands.

3. The method of claim 1, wherein the one or more linear combination codebook coefficients comprise one or more amplitude coefficients, one or more phase coefficients, or a combination thereof.

4. The method of claim 1, wherein the constructing of the linear combination-based CSI feedback comprises performing at least one of:
frequency-dependent parameterization in an amplitude part of the linear combination;
frequency-dependent parameterization in a phase part of the linear combination; or
frequency-dependent parameterization in the amplitude part and the phase part of the linear combination, with the frequency-dependent parameterization in the amplitude part and the frequency-dependent parameterization in the phase part performed separately.

5. The method of claim 4, wherein the frequency-dependent parameterization comprises a set of coefficients associated with a predefined model for interpolation at a plurality of sub-bands.

6. The method of claim 5, wherein the predefined model comprises a first-order polynomial model, a second-order polynomial model, a high-order polynomial model, a sine function model, or a spline function model.

7. The method of claim 4, wherein the constructing of the linear combination-based CSI feedback further comprises performing piece-wise frequency-dependent parameterizations over a first set of sub-bands of the plurality of sub-bands and a second set of sub-bands of the plurality of sub-bands.

8. A method, comprising:
measuring, by a processor of a user equipment (UE), one or more reference signals from a network node of a wireless network;
selecting, by the processor, a set of one or more selected beams from a plurality of beams by:
determining, based on the measuring, at least one high-power beam among the plurality of beams as a chosen beam; and
searching in a spatial region around the chosen beam to identify one or more other beams each having a power no greater than that of the chosen beam, the chosen beam and the one or more other beams being the one or more selected beams;
generating, by the processor, a report indicating the one or more selected beams; and
transmitting, by the processor, the report to the network node.

9. The method of claim 8, wherein the report comprises bit-fields that separately indicate the chosen beam with high power and other beams as the one or more selected beams.

10. The method of claim 9, wherein the report further indicates quantized linear combination codebook coefficients associated with the one or more selected beams.

11. The method of claim 9, wherein the spatial region comprises an array of multiple geometric shapes arranged in a M×N dimension of M rows and N columns centered around the chosen beam with the chosen beam in one of the geometric shapes in a center of the array, and wherein each of M and N is a positive integer.

12. The method of claim 11, wherein a shape of each of the geometric shapes is a circle, an ellipse or a polygon.

13. The method of claim 8, wherein the one or more selected beams comprise beams of different strengths, and wherein the generating of the report indicating the quantized linear combination codebook coefficients associated with the one or more selected beams comprises either or both of:
quantizing an amplitude of each linear combination codebook coefficient associated with each of the one or more selected beams using different amplitude quantization schemes based on either the different strengths of the one or more selected beams or a strength order of the one or more selected beams; and
quantizing a phase of each linear combination codebook coefficient associated with each of the one or more selected beams using different phase quantization schemes based on either the different strengths of the one or more selected beams or the strength order of the one or more selected beams.

14. The method of claim 8, wherein the one or more selected beams comprise beams of different strengths, and wherein the generating of the report indicating the quantized linear-combination codebook coefficients associated with the one or more selected beams comprises:
generating a plurality of channel realizations;
performing computation for linear combination codebook amplitude coefficients and linear combination codebook phase coefficients associated with the one or more selected beams without quantizing the amplitude coefficients and the phase coefficients;
collecting statistics regarding the amplitude coefficients and the phase coefficients for the one or more selected beams;
fitting the collected statistics to one or more distribution curves; and
identifying an optimal distribution and a corresponding optimal quantizer based on a result of the fitting.

15. The method of claim 14, wherein the fitting of the collected statistics to one or more distribution curves comprises applying a Lloyd-Max iterative algorithm on the collected statistics.

16. The method of claim 8, further comprising:
utilizing a first quantizer for the coefficients for a strong beam; and
utilizing a second quantizer for the coefficients for a weak beam,
wherein the first quantizer and the second quantizer have different settings of quantization ranges, different numbers of quantization levels, or different quantizing step sizes.

17. An apparatus, comprising:
a transceiver capable of wirelessly communicating with a network node of a wireless network; and
a processor communicatively coupled to the transceiver, the processor capable of:
receiving, via the transceiver, one or more reference signals via a communication link between the transceiver and the network node;
constructing a linear combination-based channel state information (CSI) feedback by utilizing a precoder which is a continuous function of frequency such that the CSI feedback indicates one or more linear combination codebook coefficients each being a continuous function of frequency; and
transmitting, via the transceiver, the CSI feedback to the network node.

18. The apparatus of claim 17, wherein, in constructing the linear combination-based CSI feedback, the processor performs at least one of:
frequency-dependent parameterization in an amplitude part of the linear combination;
frequency-dependent parameterization in a phase part of the linear combination; or
frequency-dependent parameterization in the amplitude part and the phase part of the linear combination, with the frequency-dependent parameterization in the amplitude part and the frequency-dependent parameterization in the phase part performed separately,
wherein the frequency-dependent parameterization comprises a set of coefficients associated with a predefined model for interpolation at a plurality of sub-bands, and
wherein the predefined model comprises a first-order polynomial model, a second-order polynomial model, a high-order polynomial model, a sine function model, or a spline function model.

19. The apparatus of claim 17, wherein the processor is further capable of:
measuring one or more reference signals from the network node;
selecting a set of one or more selected beams from a plurality of beams by:
determining, based on the measuring, at least one high-power beam among the plurality of beams as a chosen beam; and
searching in a spatial region around the chosen beam to identify one or more other beams each having a power no greater than that of the chosen beam, the chosen beam and the one or more other beams being the one or more selected beams;
generating a report indicating the one or more selected beams; and
transmitting, via the transceiver, the report to the network node.

20. The apparatus of claim 19, wherein the spatial region comprises an array of multiple geometric shapes arranged in a M×N dimension of M rows and N columns centered around the chosen beam with the chosen beam in one of the geometric shapes in a center of the array, wherein each of M and N is a positive integer, and wherein a shape of each of the geometric shapes is a circle, an ellipse or a polygon.
